(19) United States
(12) Patent Application Publication
(10) Pub. No.: US 2008/0254295 A1
(43) Pub. Date: Oct. 16, 2008

(54) Method for Preparing Surface-Modified, Nanoparticulate Metal Oxides, Metal Hydroxides and/or Metal Oxyhydroxides

(75) Inventors: Hartmut Hibst, Schriesheim (DE); Jens Rieger, Ludwigshafen (DE); Jutta Kissel, Herxheim (DE); Valerie Andre, Ludwigshafen (DE); Graham Edmund Mc Kee, Neustadt (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/088,334

(22) PCT Filed: Sep. 21, 2006
(86) PCT No.: PCT/EP2006/066569

§ 371 Date: Mar. 27, 2008

(30) Foreign Application Priority Data
Sep. 27, 2005 (DE) 10 2005 046 263.4

(51) Int. Cl. C08K 3/22; B32B 5/16

(52) U.S. Cl. 428/407; 524/403; 524/413; 524/431; 524/432; 524/433

(57) ABSTRACT

Methods are disclosed comprising: (a) mixing (i) an aqueous solution of at least one salt of at least one metal selected from the group consisting of aluminum, magnesium, cerium, iron, manganese, cobalt, nickel, titanium, zinc, zirconium and mixtures thereof with (ii) an aqueous solution of at least one polymer, at a pH value of 3 to 13 and at a temperature T1 of 0 to 50° C. to form a mixture; and (b) heating the mixture at a temperature T2 of 60 to 300° C. to form an aqueous suspension of surface-modified nanoparticulate particles comprising at least one compound selected from the group consisting of oxides, hydroxides, and oxide hydroxides of the at least one metal; along with powders prepared therefrom and uses therefore.

The present invention relates to powder compositions of surface-modified nanoparticulate particles of at least one metal oxide, metal hydroxide and/or metal oxide hydroxide, to a method for the production thereof and also to their use for cosmetic sunscreen preparations, as stabilizers in plastics and as antimicrobial active ingredient. The invention further relates to a method of producing aqueous suspensions of surface-modified nanoparticulate particles of at least one metal oxide, metal hydroxide and/or metal oxide hydroxide.

Metal oxides are used for diverse purposes, thus, for example, as white pigment as catalyst as constituent of antibacterial skin protection ointments and as activator for the vulcanization of rubber. Finely divided zinc oxide or titanium dioxide is found as UV-absorbing pigments in cosmetic sunscreen compositions.

For the purposes of the present application, the term “nanoparticles” refers to particles with an average diameter of from 5 to 10000 nm, determined by means of electron-microscopic methods.

Zinc oxide nanoparticles with particle sizes below about 30 nm are potentially suitable for use as UV absorbers in transparent organic-inorganic hybrid materials, plastics, paints and coatings. In addition, a use for protecting UV-sensitive organic pigments is also possible.

Particles, particle aggregates or particle agglomerates of zinc oxide which are larger than about 30 nm lead to scattered light effects and thus to an undesired decrease in transparency in the visible light region. The redispersibility, i.e. the ability of the prepared zinc oxide nanoparticles to be converted to a colloidally disperse state, is therefore an important prerequisite for the abovementioned applications.

Zinc oxide nanoparticies with particle sizes below about 5 nm exhibit, due to the quantum size effect, a blue shift of the absorption edge (L. Brus, J. Phys. Chem. (1986), 90, 2555-2560) and are therefore less suitable for use as UV absorbers in the UV-A region.

The production of metal oxides, for example of zinc oxide by dry and wet methods, is known. The classic method of burning zinc, which is known as a dry method (e.g. Gmelin vol. 32, 8th edition, supplementary volume, p. 772 ff.), produces aggregated particles with a broad size distribution. Although it is in principle possible to produce particle sizes in the submicrometer range by grinding processes, because the shear forces which can be achieved are too low, it is not possible to obtain dispersions with average particle sizes in the lower nanometer range from such powders. Particularly finely divided zinc oxide is produced primarily wet-chemically by precipitation processes. The precipitation in aqueous solution generally produces hydroxide- and/or carbonate-containing materials which have to be converted thermally to zinc oxide. The thermal treatment has an adverse effect on the finely divided nature since the particles are here subjected to sintering processes which lead to the formation of micrometer-sized aggregates which can only be broken down incompletely to the primary particles by grinding.

Nanoparticulate metal oxides can be obtained, for example, by the microemulsion method. In this method, a solution of a metal alkoxide is added dropwise to a water-in-oil microemulsion. In the inverse micelles of the microemulsion, the size of which is in the nanometer range, the hydrolysis of the alkoxides to the nanoparticulate metal oxide then takes place. The disadvantages of this process are, in particular, that the metal oxides are expensive starting materials, that emulsifiers have to additionally be used and that the production of the emulsions with droplet sizes in the nanometer range is a complex process step.

DE 199 07 704 describes a nanoparticulate zinc oxide produced via a precipitation reaction. In this process, the nanoparticulate zinc oxide is produced via an alkaline precipitation starting from a zinc acetate solution. The zinc oxide which has been centrifuged off can be redispersed to give a sol by adding methylene chloride. The zinc oxide dispersions produced in this way have the disadvantage that due to a lack of surface modification, they do not have good long-term stability.

WO 00/50503 describes zinc oxide gels which comprise nanoparticutate zinc oxide particles with a particle diameter of <15 nm and which are redispersible to give sols. In this process, the precipitates produced by basic hydrolysis of a zinc compound in alcohol or in an alcohol/water mixture are redispersed by adding dichloromethane or chloroform. A disadvantage here is that in water or in aqueous dispersants, stable dispersions are not obtained.

In the publication from Chem. Mater. 2000, 12, 2268-74 “Synthesis and Characterization of Poly(vinylpyrrolidone)-Modified Zinc Oxide Nanoparticles” by Lin Guo and Shihe Yang, wurtzite zinc oxide nanoparticles are surface-coated with polyvinylpyrrolidone. The disadvantage here is that zinc oxide particles coated with polyvinylpyrrolidone are not dispersible in water.

WO 93/21127 describes a method of producing surface-modified nanoparticulate ceramic powders. Here, a nanoparticulate ceramic powder is surface-modified by applying a low molecular weight organic compound, for example propionic acid. This method can not be used for the surface modification of zinc oxide since the modification reactions are carried out in aqueous solution and zinc oxide dissolves in aqueous organic acids. This method can therefore not be used for producing zinc oxide dispersions; moreover, in this application, zinc oxide is also not specified as a possible starting material for nanoparticulate ceramic powders.

JP-A-04 164 814 describes a method which leads to finely divided zinc oxide by precipitation in aqueous medium at elevated temperature even without a subsequent thermal treatment. The average particle size stated is 20-50 nm with no indication of the degree of agglomeration. These particles are relatively large. Even if agglomeration is minimal, this leads to scatter effects which are undesired in transparent applications.

JP-A-07 232 919 describes the production of zinc oxide particles of 5 to 10000 nm in size from zinc compounds through reaction with organic acids and other organic compounds, such as alcohols, at elevated temperature. The hydrolysis occurs here such that the formed by-products (esters of the acids used) can be distilled off. The method allows the production of zinc oxide powders which are redispersible by virtue of prior surface modification. However, on the basis of the disclosure of this application, it is not possible to produce particles with an average diameter of <15 nm. Accordingly, in the examples listed in the application, 15 nm is specified as the smallest average primary particle diameter.

Metal oxides that are hydrophobized with organosilicon compounds are described, inter alia, in DE 33 14 741 A1, DE 36 42 794 A1 and EP 0 603 627 A1 and also in WO 97/16156.

These metal oxides coated with silicone compounds, for example zinc oxide or titanium dioxide, have the disadvantage that oil-in-water or water-in-oil emulsions prepared therewith do not always have the required pH stability.

In addition, incompatibilities of various metal oxides coated with silicone compounds with one another are often observed, which may lead to undesired aggregate formations and to fluctuations of the different particles.

The object of the present invention was therefore to provide nanoparticulate metal oxides, metal hydroxides and/or metal oxide hydroxides which allow the production of stable nanoparticulate dispersions in water or polar organic solvents and also in cosmetic oils. Irreversible aggregation of the particles should be avoided if possible so that a complex grinding process can be avoided.

This object was achieved by a method of producing an aqueous suspension of surface-modified nanoparticulate particles of at least one metal oxide, metal hydroxide and/or metal oxide hydroxide, where the metal or metals are chosen from the group consisting of aluminum, magnesium, cerium, iron, manganese, cobalt, nickel, titanium, zinc and zirconium, wherein
a) an aqueous solution of at least one metal salt of the abovementioned metals is mixed with an aqueous solution of at least one polymer at a pH value in the range from 3 to 13 and at a temperature T1 in the range from 0 to 50° C. and
b) this mixture is then heated at a temperature T2 in the range from 60 to 300° C., at which the surface-modified nanoparticulate particles precipitate.

The metal oxide, metal hydroxide and metal oxide hydroxide can here either be the anhydrous compounds or the corresponding hydrates.

The metal salts in process step a) may be metal halides, acetates, sulfates or nitrates. Preferred metal salts here are halides, for example zinc chloride or titanium tetrachloride, acetates, for example zinc acetate, and also nitrates, for example zinc nitrate. A particularly preferred metal salt is zinc nitrate or zinc acetate.

The polymers may be, for example, polyaspartic acid, polyvinylpyrrolidone or copolymers of an N-vinylamide, for example N-vinylpyrrolidone, and at least one further monomer comprising a polymerizable group, for example with monoethylenically unsaturated C₃-C₈-carboxylic acids, such as acrylic acid, methacrylic acid, C₈-C₃₀-alkyl esters of monoethylenically unsaturated C₃-C₈-carboxylic acids, vinyl esters of aliphatic C₈-C₃₀-carboxylic acids and/or with N-alkyl- or N,N-dialkyl-substituted amides of acrylic acid or of methacrylic acid with C₈-C₁₈-alkyl radicals.

A preferred embodiment of the method according to the invention is one in which the precipitation of the metal oxide, metal hydroxide and/or of the metal oxide hydroxide takes place in the presence of polyaspartic acid. For the purposes of the present invention, the term polyaspartic acid comprises both the free acid and also the salts of polyaspartic acid, such as, for example, sodium, potassium, lithium, magnesium, calcium, ammonium, alkylammonium, zinc and iron salts or mixtures thereof.

A particularly preferred embodiment of the method according to the invention is one in which polyaspartic acid, in particular the sodium salt of polyaspartic acid having an average molecular weight of from 500 to 1000000, preferably 1000 to 20000, particularly preferably 1000 to 8000, very particularly preferably 3000 to 7000, determined by gel-chromatographic analysis, is used.

The two solutions (aqueous metal salt solution and aqueous polymer solution) are mixed in process step a) at a temperature T1 in the range from 0° C. to 50° C., preferably in the range from 15° C. to 40° C., particularly preferably in the range from 15° C. to 30° C.

Depending on the metal salts used, the mixing can be carried out at a pH value in the range from 3 to 13. In the case of zinc oxide, the pH value during mixing is in the range from 7 to 11.

The time for mixing the two solutions in process step a) is preferably in the range from 0.5 to 30 minutes, particularly preferably in the range from 0.5 to 10 minutes.

The mixing in process step a) can be done, for example, through the metered addition of the aqueous solution of a metal salt, for example of zinc acetate or zinc nitrate to an aqueous solution of a mixture of polyaspartic acid and an alkali metal hydroxide or ammonium hydroxide, in particular sodium hydroxide, or through simultaneous metered addition in each case of an aqueous solution of a metal salt and an aqueous solution of an alkali metal hydroxide or ammonium hydroxide to give an aqueous polyaspartic acid solution.

The temperature T2 in process step b) is in the range from 60 to 300° C., preferably in the range from 70 to 150° C., particularly preferably in the range from 80 to 100° C.

The residence time of the mixture in the temperature T2 chosen in process step b) is 0.1 to 30 minutes, preferably 0.5 to 10 minutes, particularly preferably 0.5 to 5 minutes.

The heating from T1 to T2 occurs within 0.1 to 5 minutes, preferably within 0.1 to 1 minute, particularly preferably within 0.1 to 0.5 minutes.

A further preferred embodiment of the method according to the invention is one in which the process steps a) and/or b) take place continuously. When operating continuously, the method is preferably carried out in a tubular reactor.

Preferably, the method is carried out in a way in which
a) the mixing is carried out in a first reaction chamber in which an aqueous solution of at least one metal salt and an aqueous solution of at least one polymer are continuously introduced, and from which the prepared reaction mixture is removed and
b) is continuously conveyed to a further reaction chamber for heating, during which the surface-modified nanoparticulate particles precipitate.

The methods described previously are particularly suitable for producing an aqueous suspension of surface-modified nanoparticulate particles of titanium dioxide and zinc oxide, in particular of zinc oxide. In this case, the precipitation of the surface-modified nanoparticulate particles of zinc oxide from an aqueous solution of zinc acetate, zinc chloride or zinc nitrate takes place at a pH value in the range from 7 to 11 in the presence of polyaspartic acid having an average molecular weight of from 1000 to 8000.

A further advantageous embodiment of the method according to the invention is one in which the surface-modified nanoparticulate particles of a metal oxide, metal hydroxide and/or metal oxide hydroxide, in particular of zinc oxide, have a BET surface area in the range from 25 to 500 m²/g, preferably 30 to 400 m²/g, particularly preferably 40 to 300 m²/g, very particularly preferably 50 to 250 m²/g.

The invention is based on the finding that, through a surface modification of nanoparticulate metal oxides, metal hydroxides and/or metal oxide hydroxides with polyaspartic acid and/or salts thereof, it is possible to achieve a long-term stability of dispersions of the surface-modified metal oxides, in particular in cosmetic preparations, without undesired pH changes during the storage of these preparations.

The invention further provides a method of producing a powder composition of surface-modified nanoparticulate particles of at least one metal oxide, metal hydroxide and/or metal oxide hydroxide, where the metal or metals are chosen from the group consisting of aluminum, magnesium, cerium, iron, manganese, cobalt, nickel, titanium, zinc and zirconium, wherein
c) an aqueous solution of at least one metal salt of the abovementioned metals is mixed with an aqueous solution of at least one polymer at a pH value in the range from 3 to 13 and at a temperature T1 in the range from 0 to 50° C. and
d) this mixture is then heated at a temperature T2 in the range from 60 to 300° C., at which the surface-modified nanoparticulate particles precipitate,
c) the precipitated particles are separated from the aqueous reaction mixture and
d) the nanoparticulate particles are then dried.

For a more detailed description of the way in which process steps a) and b) are carried out and also of the feed materials used therein, reference is made to the statements made above.

The precipitated particles can be separated from the aqueous reaction mixture in process step c) in a manner known per se, for example by filtration or centrifugation.

It has proven to be advantageous to cool the aqueous reaction mixture to a temperature T3 in the range from 10 to 50° C. before separating the precipitated particles.

The filter cake obtained can be dried in a manner known per se, for example in a drying oven at temperatures between 40 and 100° C., preferably between 50 and 70° C. under atmospheric pressure, to constant weight.

The present invention further provides powder compositions of surface-modified nanoparticulate particles of at least one metal oxide, metal hydroxide and/or metal oxide hydroxide, where the metal or metals are chosen from the group consisting of aluminum, magnesium, cerium, iron, titanium, manganese, cobalt, nickel, zinc and zirconium, and the surface modification comprises a coating with at least one polymer, obtainable by the methods described at the start.

Furthermore, the present invention further provides powder compositions of surface-modified nanoparticulate particles of at least one metal oxide, metal hydroxide and/or metal oxide hydroxide, in particular of zinc oxide, where the surface modification comprises a coating with polyaspartic acid, having a BET surface area in the range from 25 to 500 m²/g, preferably 30 to 400 m²/g, particularly preferably 40 to 300 m²/g, very particularly preferably 50 to 250 m²/g.

The present invention further provides the use of powder compositions of surface-modified nanoparticulate particles of at least one metal oxide, metal hydroxide and/or metal oxide hydroxide, in particular titanium dioxide or zinc oxide, which are produced by the method according to the invention, for example

for UV protection in cosmetic sunscreen preparations, or
as stabilizer in plastics, or
as antimicrobial active ingredient.

According to a preferred embodiment of the present invention, the surface-modified nanoparticulate particles of at least one metal oxide, metal hydroxide and/or metal oxide hydroxide, in particular titanium dioxide or zinc oxide, are redispersible in a liquid medium and forms stable dispersions. This is particularly advantageous because, for example, the dispersions produced from the zinc oxide according to the invention do not have to be dispersed again prior to further processing, but can be processed directly.

According to a preferred embodiment of the present invention, the surface-modified nanoparticulate particles of at least one metal oxide, metal hydroxide and/or metal oxide hydroxide are redispersible in polar organic solvents and forms stable dispersions. This is particularly advantageous since, as a result of this, uniform incorporation for example into plastics or films is possible.

According to a further preferred embodiment of the present invention, the surface-modified nanoparticulate particles of at least one metal oxide, metal hydroxide and/or metal oxide hydroxide are redispersible in water, where it forms stable dispersions. This is particularly advantageous since this opens up the possibility of using the material according to the invention, for example, in cosmetic formulations, where the omission of organic solvents constitutes a major advantage. Also conceivable are mixtures of water and polar organic solvents.

According to a preferred embodiment of the present invention, the surface-modified nanoparticulate particles have a diameter of from 10 to 200 nm. This is particularly advantageous since good redispersibility is ensured within this size distribution.

According to a particularly preferred embodiment of the present invention, the surface-modified nanoparticulate particles have a diameter of from 10 to 50 nm. This size range is particularly advantageous since, for example, following redispersion of such zinc oxide nanoparticles, the dispersions which form are transparent and thus do not influence the coloring, for example, when added to cosmetic formulations. Moreover, this also gives rise to the possibility of use in transparent films.

By reference to the examples below, the intention is to illustrate the invention in more detail.

### EXAMPLE 1

### Continuous Production of Surface-Modified Zinc Oxide

Two solutions A and B were firstly prepared. Solution A comprised 43.68 g of zinc acetate dihydrate per liter and had a zinc concentration of 0.2 mol/l.

Solution B comprised 16 g of sodium hydroxide per liter and thus had a sodium hydroxide concentration of 0.4 mol/l. Moreover, solution B also comprised 20 g/l of sodium polyaspartate.

5 l of water with a temperature of 25° C. were placed in a glass reactor with a total volume of 8 l and stirred at a rotary speed of 250 rpm. With further stirring, the solutions A and B were continuously metered into the initial charge of water by means of 2 HPLC pumps (Knauer, model K 1800, pump head 500 ml/min) via two separate inlet pipes each at a metering rate of 0.48 l/min. A white suspension formed in the glass reactor. At the same time, by means of a toothed-wheel pump (Gather Industrie GmbH, D-40822 Mettmann), a suspension stream was pumped off from the glass reactor via a riser pipe at 0.96 l/min and heated to a temperature of 85° C. in a downstream heat exchanger within 1 minute. The suspension obtained then flowed through a second heat exchanger in which the suspension was kept at 85° C. for a further 30 seconds. The suspension then flowed successively through a third and fourth heat exchanger in which the suspension was cooled to room temperature within a further minute. The suspension obtained was collected in drums.

After the apparatus had been in operation for 90 minutes, part of the freshly produced suspension was diverted and concentrated by evaporation by a factor of 15 in a crossflow-ultrafiltration laboratory system (Sartorius, model SF Alpha, PES cassette, cut off 100 kD). The subsequent isolation of the solid powder was carried out using an ultracentrifuge (Sigma 3K30, 20000 rpm, 40700 g).

The resulting powder had, in the UV-VIS spectrum, the absorption band characteristic of zinc oxide at about 350-360 nm. In agreement with this, the X-ray diffraction of the powder displayed exclusively the diffraction reflections of hexagonal zinc oxide. The half-width of the X-ray reflections was used to calculate a crystallite size, which is between 8 nm [For the (102) reflection] and 37 nm [for the (002) reflection]. Measurement of the particle size distribution by means of laser diffraction led to a monomodal particle size distribution. The specific BET surface area was 42 m²/g. In the scanning electron microscope (SEM) and likewise in transmission electron microscopy (TEM), the powder obtained had an average particle size of from 50 to 100 nm. Moreover, the TEM micrograph showed that the zinc oxide particles have a very high porosity and consist of very small primary particles with a diameter of 5-10 nm.

### EXAMPLE 2

### Semicontinuous Production of Surface-Modified Zinc Oxide

4 l of solution A from example 1 were initially introduced into a glass reactor with a total volume of 12 l and stirred (250 rpm). Using an HPLC pump (Knauer, model K 1800, pump head 1000 ml/min), 4 l of solution B were metered into the stirred solution at room temperature over the course of 6 minutes. A white suspension formed in the glass reactor.

Immediately after the metered addition was complete, by means of a toothed-wheel pump (Gather Industrie GmbH, D-40822 Mettmann), a suspension stream was pumped off from the resulting suspension via a riser pipe at 0.96/min and heated to a temperature of 85° C. in a downstream heat exchanger over the course of 1 minute. The resulting suspension then flowed through a second heat exchanger in which the suspension was kept at 85° C. for a further 30 seconds. The suspension then successively flowed through a third and fourth heat exchanger in which the suspension was cooled to room temperature over the course of a further minute. The resulting suspension was collected in drums.

After the apparatus had been in operation for 5 minutes, part of the freshly produced suspension was diverted and thickened by a factor of 15 in a crossflow-ultrafiltration laboratory system (Sartorius, model SF Alpha, PES cassette, cut off 100 kD). Subsequent isolation of the solid powder was carried out using an ultracentrifuge (Sigma 3K30, 20000 rpm, 40700 g).

The product obtained had, in the UV-VIS spectrum, the absorption band characteristic of zinc oxide at about 350-360 nm. In agreement with this, the X-ray diffraction of the powder exhibited exclusively the diffraction reflections of hexagonal zinc oxide. The half-width of the X-ray reflections was used to calculate a crystallite size, which is between 8 nm [for the (102) reflection] and 37 nm [for the (002) reflection]. Measurement of the particle size distribution by means of laser diffraction led to a monomodal particle size distribution. The specific BET surface area was 42 m²/g. In the scanning electron microscope (SEM) and likewise in transmission electron microscopy (TEM), the powder obtained had an average particle size of from 50 to 100 nm. Moreover, the TEM micrograph showed that the zinc oxide particles have a very high porosity and consist of very small primary particles having a diameter of 5-10 nm.

### EXAMPLE 3

### Continuous Production of Surface-Modified Iron-Doped Zinc Oxide

Two solutions C and D were firstly prepared. Solution C comprised 41.67 g of zinc acetate dehydrate and 2.78 g of iron(II) sulfate heptahydrate per liter and had a zinc concentration of 0.19 mol/l and an iron(II) concentration of 0.01 mol/l.

Solution D comprised 16 g of sodium hydroxide per liter and thus had a sodium hydroxide concentration of 0.4 mol/l. Moreover, solution D also comprised 5 g/l of sodium polyaspartate.

5 l of water were initially introduced into a glass reactor with a total volume of 8 l and stirred (250 rpm). With further stirring, solutions C and D were metered in by means of two HPLC pumps and further treated as in example 1.

The resulting powder had, in the UV-VIS spectrum, the absorption band characteristic of zinc oxide at about 350-360 nm. In agreement with this, the X-ray diffraction of the powder displayed exclusively the diffraction reflections of hexagonal zinc oxide with somewhat larger lattice parameters compared to nondoped zinc oxide. In the scanning electron microscope (SEM) and likewise in transmission electron microscopy (TEM), the powder obtained had an average particle size of from 50 to 100 nm. Moreover, the TEM micrograph showed that the zinc-iron oxide particles of the formula Zn_{0.95}Fe_{0.05}O have a very high porosity and consist of very small primary particles with a diameter of 5-10 nm. Energy-dispersive X-ray analysis (EDX) confirmed homogeneous distribution of zinc ions and iron ions in the sample.

### EXAMPLE 4

### Semicontinuous Production of Surface-Modified Iron-Doped Zinc Oxide

4 l of solution C from example 3 were initially introduced into a glass reactor and stirred (250 rpm). Using an HPLC pump, 4 l of solution D from example 3 were added to the stirred solution. The mixture was further treated as in example 2.

The powder obtained had, in the UV-VIS spectrum, the absorption band characteristic of zinc oxide at about 350-360 nm. In agreement with this, the X-ray diffraction of the powder exhibited exclusively the diffraction reflections of hexagonal zinc oxide with somewhat larger lattice parameters compared to nondoped zinc oxide. In the scanning electron microscope (SEM) and likewise in transmission electron microscopy (TEM), the powder obtained had an average particle size of from 50 to 100 nm. Moreover, the TEM micrograph showed that the zinc-iron oxide particles of the formula Zn_{0.95}Fe_{0.05}O have a very high porosity and consist of very small primary particles having a diameter of 5-10 nm. Energy-dispersive X-ray analysis (EDX) confirmed homogeneous distribution of zinc ions and iron ions in the sample.

### EXAMPLE 5

### Continuous Production of Surface-Modified Iron Oxide of the Formula Fe₃O₄

Two solutions E and F were firstly prepared. Solution E comprised 55.60 g of iron(II) sulfate heptahydrate and 101.59 g of iron(III) sulfate hexahydrate per liter and had an iron(II) concentration of 0.2 mol/l and an iron(III) concentration of 0.4 mol/l.

Solution F comprised 70.4 g of sodium hydroxide per liter and thus had a sodium hydroxide concentration of 1.76 mol/l. Moreover, solution F also comprised 5 g/l of sodium polyaspartate.

5 l of water were initially introduced into a glass reactor with a total volume of 8 l and stirred (250 rpm). With further stirring, solutions E and F were metered in by means of two HPLC pumps and further treated as in example 1.

The X-ray diffraction of the resulting black powder displayed exclusively the diffraction reflections of cubic iron oxide of the formula Fe₃O₄. The half-width of the X-ray reflections was used to calculate a crystallite size of about 10 nm. In transmission electron microscopy (TEM), the powder obtained had an average particle size of from 5 to 15 nm.

### EXAMPLE 6

### Semicontinuous Production of Surface-Modified Iron Oxide of the Formula Fe₃O₄

4 l of solution E from example 5 were initially introduced into a glass reactor and stirred (250 rpm). 4 l of solution F from example 5 were added to the stirred solution using a HPLC pump. The mixture was further treated as in example 2.

The X-ray diffraction of the resulting black powder displayed exclusively the diffraction reflections of cubic iron oxide of the formula Fe₃O₄. The half-width of the X-ray reflections was used to calculate a crystallite size of about 10 nm. In transmission electron microscopy (TEM), the powder obtained had an average particle size of from 5 to 15 nm.

### EXAMPLE 7

### Continuous Production of Surface-Modified Manganese-Iron Oxide of the Formula MnFe₂O₄

Two solutions G and H were firstly prepared. Solution G comprised 33.80 g of manganese(II) sulfate monohydrate and 101.59 g of iron(III) sulfate hexahydrate per liter and had a manganese(II) concentration of 0.2 mol/l and an iron(III) concentration of 0.4 mol/l.

Solution H comprised 70.4 g of sodium hydroxide per liter and thus had a sodium hydroxide concentration of 1.76 mol/l. Moreover, solution H also comprised 5 g/l of sodium polyaspartate.

5 l of water were initially introduced into a glass reactor with a total volume of 8 l and stirred (250 rpm). With further stirring, solutions G and H were metered in by means of two HPLC pumps and further treated as in example 1.

The X-ray diffraction of the resulting black powder displayed exclusively the diffraction reflections of cubic manganese-iron oxide of the formula MnFe₂O₄. The half-width of the X-ray reflections were used to calculate a crystallite size of about 10 nm. In transmission electron microscopy (TEM), the powder obtained had an average particle size of from 5 to 15 nm.

### EXAMPLE 8

### Semicontinuous Production of Surface-Modified Manganese-Iron Oxide of the Formula MnFe₂O₄

4 l of solution G from example 7 were initially introduced into a glass reactor and stirred (250 rpm). 4 l of solution H from example 7 were added to the stirred solution by means of a HPLC pump. The mixture was further treated as in example 2.

The X-ray diffraction of the resulting black powder displayed exclusively the diffraction reflections of cubic manganese-iron oxide of the formula MnFe₂O₄. The half-width of the X-ray reflections was used to calculate a crystallite size of about 10 nm. In transmission electron microscopy (TEM), the powder obtained had an average particle size of from 5 to 15 nm.

### EXAMPLE 9

### Continuous Production of Surface-Modified Zinc-Doped Manganese-Iron Oxide of the Formula MnFe₂O₄

Two solutions I and J were firstly prepared. Solution I comprised 30.42 g of manganese(II) sulfate monohydrate, 3.59 g of zinc sulfate monohydrate and 101.59 g of iron(III) sulfate hexahydrate per liter and had a manganese(II) concentration of 0.18 mol/l, a zinc concentration of 0.02 mol/l and an iron(III) concentration of 0.4 mol/l.

Solution J comprised 70.4 g of sodium hydroxide per liter and thus had a sodium hydroxide concentration of 1.76 mol/l. Moreover, solution J also comprised 5 g/l of sodium polyaspartate.

5 l of water were initially introduced into a glass reactor with a total volume of 8 l and stirred (250 rpm). With further stirring, solutions I and J were metered in by means of two HPLC pumps and further treated as in example 1.

The X-ray diffraction of the resulting black powder displayed exclusively the diffraction reflections of cubic manganese-iron oxide of the formula MnFe₂O₄ with somewhat smaller lattice parameters compared to nondoped MnFe₂O₄. The half-width of the X-ray reflections was used to calculate a crystallite size of about 10 nm. In transmission electron microscopy (TEM), the powder obtained had an average particle size of from 5 to 15 nm. Energy-dispersive X-ray analysis (EDX) confirmed homogeneous distribution of manganese ions, zinc ions and iron ions in the sample.

### EXAMPLE 10

### Semicontinuous Production of Surface-Modified Zinc-Doped Manganese-Iron Oxide of the Formula MnFe₂O₄

4 l of solution I from example 9 were initially introduced into a glass reactor and stirred (250 rpm). 4 l of solution J from example 9 were added to the stirred solution by means of a HPLC pump. The mixture was further treated as in example 2.

The X-ray diffraction of the resulting black powder displayed exclusively the diffraction reflections of cubic manganese-iron oxide of the formula MnFe₂O₄ with somewhat smaller lattice parameters compared to nondoped MnFe₂O₄. The half-width of the X-ray reflections was used to calculate a crystallite size of about 10 nm. In transmission electron microscopy (TEM), the powder obtained had an average particle size of from 5 to 15 nm. Energy-dispersive X-ray analysis (EDX) confirmed homogeneous distribution of manganese ions, zinc ions and iron ions in the sample.

### EXAMPLE 11

### Continuous Production of Surface-Modified Nickel-Iron Oxide of the Formula NiFe₂O₄

Two solutions K and L were firstly prepared. Solution K comprised 52.57 g of nickel(II) sulfate hexahydrate and 101.59 g of iron(III) sulfate hexahydrate per liter and had a nickel(II) concentration of 0.2 mol/l and an iron(111) concentration of 0.4 mol/l.

Solution L comprised 70.4 g of sodium hydroxide per liter and thus had a sodium hydroxide concentration of 1.76 mol/l. Moreover, solution L also comprised 5 g/l of sodium polyaspartate.

5 l of water were initially introduced into a glass reactor with a total volume of 8 l and stirred (250 rpm). With further stirring, solutions K and L were metered in by means of two HPLC pumps and further treated as in example 1.

The X-ray diffraction of the resulting black powder displayed exclusively the diffraction reflections of cubic nickel-iron oxide of the formula NiFe₂O₄. The half-width of the X-ray reflections was used to calculate a crystallite size of about 10 nm. In transmission electron microscopy (TEM), the powder obtained had an average particle size of from 5 to 15 nm.

### EXAMPLE 12

### Semicontinuous Production of Surface-Modified Nickel-Iron Oxide of the Formula NiFe₂O₄

4 l of solution K from example 11 were initially introduced into a glass reactor and stirred (250 rpm). 4 l of solution L from example 11 were added to the stirred solution by means of a HPLC pump. The mixture was further treated as in example 2.

The X-ray diffraction of the resulting black powder displayed exclusively the diffraction reflections of cubic nickel-iron oxide of the formula NiFe₂O₄. The half-width of the X-ray reflections was used to calculate a crystallite size of about 10 nm, In transmission electron microscopy (TEM), the powder obtained had an average particle size of from 5 to 15 nm.

### EXAMPLE 13

### Continuous Production of Surface-Modified Zinc-Doped Nickel-Iron Oxide of the Formula NiFe₂O₄

Two solutions M and N were firstly prepared for the following examples. Solution M comprised 47.31 g of nickel(II) sulfate hexahydrate, 3.59 g of zinc sulfate monohydrate and 101.59 g of iron(III) sulfate hexahydrate per liter and had a nickel(II) concentration of 0.18 mol/l, a zinc concentration of 0.02 mol/l and an iron(III) concentration of 04 mol/l.

Solution N comprised 70.4 g of sodium hydroxide per liter and thus had a sodium hydroxide concentration of 1.76 mol/l. Moreover, solution N also comprised 5 g/l of sodium polyaspartate.

5 l of water were initially introduced into a glass reactor with a total volume of 8 l and stirred (250 rpm). With further stirring, solutions M and N were metered in by means of two HPLC pumps and further treated as in example 1.

The X-ray diffraction of the resulting black powder displayed exclusively the diffraction reflections of cubic nickel-iron oxide of the formula NiFe₂O₄ with somewhat smaller lattice parameters compared to nondoped NiFe₂O₄. The half-width of the X-ray reflections was used to calculate a crystallite size of about 10 nm. In transmission electron microscopy (TEM), the powder obtained had an average particle size of from 5 to 15 nm. Energy-dispersive X-ray analysis (EDX) confirmed homogeneous distribution of nickel ions, zinc ions and iron ions in the sample.

### EXAMPLE 14

### Semicontinuous Production of Surface-Modified Zinc-Doped Nickel-Iron Oxide of the Formula NiFe₂O₄

4 l of solution M from example 13 were initially introduced into a glass reactor and stirred (250 rpm). 4 l of solution N from example 13 were added to the stirred solution by means of a HPLC pump. The mixture was further treated as in example 2.

The X-ray diffraction of the resulting black powder displayed exclusively the diffraction reflections of cubic nickel-iron oxide of the formula NiFe₂O₄ with somewhat smaller lattice parameters compared to nondoped NiFe₂O₄ The half-width of the X-ray reflections was used to calculate a crystallite size of about 10 nm. In transmission electron microscopy (TEM), the powder obtained had an average particle size of from 5 to 15 nm. Energy-dispersive X-ray analysis (EDX) confirmed homogeneous distribution of nickel ions, zinc ions and iron ions in the sample.

1-22. (canceled)

23. A method comprising:
(a) mixing (i) an aqueous solution of at least one salt of at least one metal selected from the group consisting of aluminum, magnesium, cerium, iron, manganese, cobalt, nickel, titanium, zinc, zirconium and mixtures thereof with (ii) an aqueous solution of at least one polymer, at a pH value of 3 to 13 and at a temperature T1 of 0 to 50° C. to form a mixture; and
(b) heating the mixture at a temperature T2 of 60 to 300° C. to form an aqueous suspension of surface-modified nanoparticulate particles comprising at least one compound selected from the group consisting of oxides, hydroxides, and oxide hydroxides of the at least one metal.

24. The method according to claim 23, wherein the mixing is carried out at a temperature T1 of 15 to 40° C.

25. The method according to claim 23, wherein heating the mixture is carried out at a temperature T2 of 70 to 150° C.

26. The method according to claim 24, wherein heating the mixture is carried out at a temperature T2 of 70 to 150° C.

27. The method according to claim 23, wherein the change from the temperature T1 to the temperature T2 occurs within 0.1 to 5 minutes.

28. The method according to claim 23, wherein the heating of the mixture at the temperature T2 is carried out over a time of 0.1 to 30 minutes.

29. The method according to claim 23, wherein the at least one polymer comprises a component selected from the group consisting of polyaspartic acid, polyvinylpyrrolidone, copolymers of an N-vinylamide and at least one further monomer comprising a polymerizable group, and mixtures thereof.

30. The method according to claim 23, wherein the at least one polymer comprises polyaspartic acid having an average molecular weight of 500 to 1,000,000.

31. The method according to claim 23, wherein the at least one salt comprises one or more selected from the group consisting of metal halides, metal acetates, metal sulfates, and metal nitrates.

32. The method according to claim 23, wherein the mixing, the heating or both are carried out continuously.

33. The method according to claim 32, wherein the mixing is carried out in a first reaction chamber in which the aqueous solution of the at least one salt and the aqueous solution of the at least one polymer are continuously introduced, and from which the mixture is removed; and further comprising continuously conveying the mixture to a second reaction chamber in which the heating is carried out.

34. The method according to claim 23, wherein the at least one compound comprises zinc oxide.

35. The method according to claim 34, wherein the at least one salt of the at least one metal comprises one or more selected from the group consisting of zinc acetate, zinc chloride, and zinc nitrate; and wherein the pH value is 7 to 11; and wherein the at least one polymer comprises polyaspartic acid having an average molecular weight of 1,000 to 8,000.

36. A method comprising:
(a) mixing (i) an aqueous solution of at least one salt of at least one metal selected from the group consisting of aluminum, magnesium, cerium, iron, manganese, cobalt, nickel, titanium, zinc, zirconium and mixtures thereof with (ii) an aqueous solution of at least one polymer, at a pH value of 3 to 13 and at a temperature T1 of 0 to 50° C. to form a mixture;
(b) heating the mixture at a temperature T2 of 60 to 300° C. to form an aqueous suspension of surface-modified nanoparticulate particles comprising at least one compound selected from the group consisting of oxides, hydroxides, and oxide hydroxides of the at least one metal;
(c) separating at least a portion of the surface-modified nanoparticulate particles from the aqueous suspension; and
(d) drying the separated surface-modified nanoparticulate particles to form a powder composition comprising the separated surface-modified nanoparticulate particles.

37. The method according to claim 36, wherein the at least one polymer comprises polyaspartic acid.

38. The method according to claim 36, wherein the aqueous suspension is cooled to a temperature T3 of 10 to 50° C. before separating the portion of the surface-modified nanoparticulate particles.

39. The method according to claim 36, wherein the at least one salt comprises one or more selected from the group consisting of metal halides, metal acetates, metal sulfates, and metal nitrates.

40. The method according to claim 36, wherein the separated surface-modified nanoparticulate particles in the powder composition comprise zinc oxide and have a BET surface area of 25 to 500 m²/g.

41. The method according to claim 36, wherein the mixing, the heating and the separating are carried out continuously.

42. A powder composition prepared by a method according to claim 36, the composition comprising the separated surface-modified nanoparticulate particles having a surface modification comprising a coating of the at least one polymer.

43. The powder composition according to claim 42, wherein the separated surface-modified nanoparticulate particles have a BET surface area of 25 to 500 m²/g.

44. The powder composition according to claim 43, wherein the surface modification comprises a coating comprising polyaspartic acid.

45. The powder composition according to claim 44, wherein the at least one compound comprises zinc oxide.
